(19) United States
(12) Patent Application Publication
(10) Pub. No.: US 2026/0332566 A1
(43) Pub. Date: Oct. 22, 2026

(54) METHOD FOR CREATING PUBLIC AND PRIVATE INTENT MANAGER PROFILES

(71) Applicant: Telefonaktiebolaget LM Ericsson (publ), Stockholm (SE)

(72) Inventors: Jörg NIEMÖLLER, Sollentuna (SE); Pedro Henrique GOMES DA SILVA, São Paulo (BR)

(73) Assignee: Telefonaktiebolaget LM Ericsson (publ), Stockholm (SE)

(21) Appl. No.: 19/486,627

(22) PCT Filed: May 22, 2023
(86) PCT No.: PCT/EP2023/063601

§ 371 Date: Nov. 21, 2025

(51) Int. Cl. H04L 9/40; H04L 9/08

(52) U.S. Cl. CPC H04L 63/0428; H04L 9/0819

(57) ABSTRACT

According to one aspect, a method performed by a first intent manager in a communications network for registering an intent manager profile is provided. The method includes obtaining a first public encryption key. The method includes obtaining an intent manager profile, wherein the intent manager profile comprises a first set of information and a second set of information. The method includes generating a first message, the first message comprising the first set of information and the first public encryption key. The method includes transmitting the first message towards an intent manager registry.

### TECHNICAL FIELD

Disclosed are embodiments related to intent-driven management, service management, and orchestration.

### BACKGROUND

Network operations of the future require higher network autonomy, which means that business, service, and resource operations are able to make decisions and take the right actions based on goals and requirements that are set by service consumers or other autonomous systems. The decision-making processes in autonomous networks should take place, ideally, without any human intervention. In this scenario, the business objectives as well as the expectations of customers and users are communicated to the parts (e.g., management domains, systems) that constitute the autonomous network by means of intents.

Intent-driven management is a new paradigm in network and services management, where the main objective is to move networks operations from manual or automated towards fully autonomous networks. Any autonomous system needs to take decisions; therefore, it is essential that autonomous systems know its requirements, goals, and constraints. The intents are the knowledge that enable autonomous systems to make intelligent decisions. Intents express “what” should be achieved and does not prescribe “how” it should be done; the final decisions are made by the autonomous system. The intents should be used by the receiving system (autonomous system) to understand what is expected to be achieved, including utility models, preferential outcomes, etc.

Intents are defined as “the formal specification of all expectations including requirements, goals, and constraints given to a technical system” [1]. This definition is commonly used throughout different standardization groups, such as the TM Forum, the 3^{rd} Generation Partnership Project (3GPP) SA5, and the European Telecommunications Standards Institute (ETSI) ZSM. One important aspect of the intents definition is that it should be a formal specification, which means that intents should be expressed with formally defined and complete semantics and vocabulary. This is achieved with the definition of formal models that cover the required expressiveness. Another important aspect is that intents are primarily intended for technical systems, or in other words, for machines. Therefore, there should be standardized interfaces that allow machines to exchange, negotiate and life cycle manage the intents.

There are different possibilities for modeling intents and how they are formally expressed. Since intents need to be used in multi-vendor and multi-domain environments, a common modeling and language is required for interoperability. TM Forum's Autonomous Networks project has worked on a set of guidelines and specifications that provide the details on the use of intent in autonomous networks and the formal intent modeling [1-6].

In any management system (that may be composed by sub-systems), intents are knowledge used for the communication of requirements, goals, and constraints between two entities, named intent managers, or intent management functions. As knowledge objects, the life cycle of intents can be managed, i.e., new intents can be created, existing intents may be changed, intents can be removed from (sub)systems, etc. Each intent manager will play a distinct role in the life cycle of the intents, either as an intent owner (the origin of the intent, who has the requirements, goals, and constraints) or as the intent handler (the receiver of the intent, who must fulfil the requirements, goals, and constraints).

When an intent owner creates an intent to specify a set of requirements, goals, or constraints, it creates an intent object instance that should be uniquely identified in the management (sub)system. In practical scenarios with multiple layers of management and autonomous domains, multiple intent managers are needed, and they may play the roles of owner and/or handler for different intent object instances depending on the direction of the communication that is required. An intent object instance, however, is owned by one single intent owner, and it must be sent to one single intent handler for its fulfilment.

The intent manager registry is a logical entity that has the intent manager capability profiles of registered intent managers. It allows intent managers to discover each other and query their supported management scopes, interface procedures and expressiveness (intent models supported and partially supported).

During the task of intent distribution, the intent owner must find the right intent handler for the specific intent object instance, and this is done using the intent manager registry capabilities, as shown in FIG. 1. FIG. 1 illustrates intent managers 102A-B, and an intent manager registry 104 with intent manager capability profiles 106. As described in [5], the intent manager registry function 104 stores information about all available intent managers 102A-B. Furthermore, it enables the discovery of intent managers through queries about the profiles 106. The interfaces of the intent manager registry are shown in FIG. 1. The intent manager registration interface allows uploading intent manager capability profiles to the intent manager registry. This publishes the presence of an intent manager and its scope and capabilities. The intent manager discovery interface allows searches in the published intent manager capability profiles.

Intent manager discovery is essential for intent owners deciding if they can use intent towards an autonomous domain and what they can express with this intent. The discovery answers the question if there is a respective intent manager present in the system with a scope that matches the target domain. On the other hand, intent handlers need discovery to get access to the capabilities of the intent owner.

An intent manager capability profile 200 can be expressed using the model defined in FIG. 2. As described in [5], intent managers differ with respect to the domain they manage, but also regarding their capabilities. They might support a different set of intent extension models, serialization formats and intent interface procedures. This model defines vocabulary for expressing these aspects of an intent manager capability and thus allow to formulate an intent manager capability profile.

Intent manager address and contact information specifies how to contact the instance of the intent managemers the profile is about. This is used for addressing of messages on the intent interface towards this instance. The string can for example contain the IRI that is representing the intent manager instance.

Intent Management Scope defines the intent management scope(s) this intent manager is responsible for. Usually there is one scope per intent manager, but it is allowed to define multiple scopes if the responsibility of this instance of the intent manager extents to all of them. The scope Identifier usually implies a domain specific implementation of the intent manager. Further differentiation of scopes is possible if the domain is further partition with multiple instances of intent management. This can for example be geographic partitioning if the network is divided into separately operated regions.

Intent LSM role. An intent manager has the capability to take the role of an intent owner, intent handler or both. An intent handler that only takes the owner role is usually a top-level source of intent. It would be associated with user portals or management functions that define requirements, but are themselves not intent aware.

Supported notation format. Intent and intent reports are knowledge graphs in the form of an ontology. For sending them over the intent interface these graphs need to be serialized. Multiple notation formats are available for this, for example TURTLE, RDF/XML or JSON-LD. The intent manager states its support for notation formats in its capability profile. It can further differentiate by supported version of the notation format.

Supported interface procedures. The intent interface defines four sets of procedures: (1) the SET/REMOVE/REPORT interface procedure. One version of this procedure is mandatory to support; (2) the JUDGE/PREFERENCE interface procedure; (3) the PROBE/ESTIMATE interface procedure; (4) the BEST/PROPOSAL interface procedure. The intent manager capability model specifies which of them is supported. Options are defined in the intent interface ontology. The model allows specifying which versions of the interface procedures are supported. In this respect it is sensible to also specify the mandatory SET/REMOVE/REPORT procedure and state which exact version are supported.

Supported Models defines the models that can be used in intent and intent reports and would be understood by the intent manager. This implicitly defines the model federation that is possible to use with the intent manger. It is possible to define models that are considered fully supported with the imp: supportedModels property and then define exceptions with the imp: notSupportedModel Artifact property. Alternatively, it is possible to mention a model as partially supported with the imp: partially SupportedModels property. This requires that all model artifacts that are supported must be explicitly mentioned with the imp: supportedModel Artifact property. It is further possible to state separately if a model and its artifacts are supported by the intent manger when it has the role of intent owner or intent handler. This means some models are only supported in intents that are received and other only in intents that the intent manager creates and sends to other intent managers for handling. Model artifacts that can be explicitly supported or not refers to the entire vocabulary specified by the model. Typical examples are classes, properties and individuals defined in the model.

### SUMMARY

Intent managers can receive intents from different sources. For instance, an intent manager that is developed by one network operator (or vendor) can receive and send intents to other intent managers either developed by the same network operator (or vendor) or by competitors. Intent managers from different operators may also exchange intents. Furthermore, intents may also come from other vertical industries towards network operators.

The intent models specified by IG1253 [1] are composed by a common set of classes and properties that form an intent common model, in addition to specific intent model extensions. The intent common model is detailed in TM Forum's TR290 [2], while the intent model extensions are detailed in a series of documents that are defined in TR291 [3]. The intent model extensions can be developed independently by other standardization organizations besides TM Forum, as well by other companies (e.g., vendors, operators, etc.) interested in developing models for specific management domains, e.g., radio access networks (RAN), transport, cloud, internet of things (IoT), etc.

The developer of intent managers may create intent model extensions that enable the support of intents that are very specialized, e.g., for optimal performance, cost, or to deliver proprietary features. For instance, a vendor that develops intent managers with the scope of transport management may develop intent extension models that allow the specification of fine-grained requirements and constraints, thus, exposing more expressiveness to the intent owner that creates an intent based on these specialized models.

For business reasons, some of the intent extension models should not be used to create intents that are originated from specific intent managers. For instance, a vendor may not want to expose detailed requirements to be expressed by intents coming from a competitor's intent manager; or one operator may want to hide internal requirement details when sending (or receiving) intents to (from) another operator; even further, depending on contractual conditions, operators may want to expose more capabilities for intent expression to specific vertical industries, or specific partners.

Furthermore, optional interface procedures may be provided by the intent managers and these capabilities could be used only for communication with specific types of intent managers, e.g., only intent managers within the same operator's domain, or only between same vendors due to any business or technical reason.

Current standardization of an intent manager registry and how intent manager profiles are expressed does not support an informed decision on the exposure of an intent manager supported models, the interface optional procedures, etc. Ideally, different intent manager profiles should be used during the intent handler discovery phase, so that the right level of capabilities (models, interface methods, etc.) exposure can be achieved.

Aspects of the present disclosure include techniques that allow intent managers playing the role of intent handlers to create different versions of intent manager profiles to be used by different intent owners. This allows the intent handler to hide information to a desired level of detail by means of selecting the best intent extension models and interface procedures to be used by other intent owners that are interested in sending an intent object.

In some aspects, the techniques disclosed herein may be based on the management functions and the intent models standardized by TM Forum standards, but can be extended to other standards as the concept of intent is incorporated into other management architectures, e.g., in the Open RAN Alliance's (O-RAN) service management and orchestration (SMO) platform, ETSI ZSM management architecture, or 3GPP SA5 management services.

Aspects of the present disclosure are based on the encryption of parts of the intent manager profile to restrict the intent managers that are allowed to read and understand those parts. In some embodiments, the encryption is achieved using a public/private key encryption algorithm.

In some embodiments, the intent manager creates two versions of an intent manager profile: (1) a public intent manager profile, which is not encrypted and can be read by any intent manager, and (2) a private intent manager profile, which has parts of it encrypted and can only be read by allowed intent managers (that have the right key to decrypt the profile). Alternatively, the intent manager can also create a profile that has some encrypted and unencrypted parts, potentially with encrypted parts using different public keys. In this latter case, one single intent manager profile can be read differently by many intent managers, i.e., the unencrypted parts can be read by any intent manager while each encrypted part can be read only by intent managers that have the right key to decrypt them.

According to one aspect, a method performed by a first intent manager in a communications network for registering an intent manager profile is provided. The method includes obtaining a first public encryption key. The method includes obtaining an intent manager profile, wherein the intent manager profile comprises a first set of information and a second set of information. The method includes generating a first message, the first message comprising the first set of information and the first public encryption key. The method includes transmitting the first message towards an intent manager registry.

In some embodiments, the method further includes obtaining a second public encryption key associated with a second intent manager and encrypting the second set of information using the second public encryption key. In some embodiments, the method further includes generating a second message, the second message comprising the encrypted second set of information, and transmitting the second message towards the intent manager registry. In some embodiments, the method further includes generating a third message, the third message comprising the first set of information, the first public encryption key, and the second set of information, and transmitting the third message towards the intent manager registry.

In some embodiments, the method further includes obtaining the second public encryption key from the intent manager registry or a certificate authority.

In some embodiments, the intent manager profile comprises a third set of information, and the method further includes obtaining a third public encryption key of a third intent manager, and encrypting the third set of information using the third public encryption key.

In some embodiments, the first set of information comprises public information about the first intent manager.

In some embodiments, the second set of information comprises capabilities supported by the first intent manager that should be interpreted by the second intent manager and not a third intent manager different than the second intent manager.

In some embodiments, the second set of information supports one or more intents relating to at least one of: optimal performance, cost, or delivery of a proprietary feature in a communications network.

In some embodiments, the second intent manager belongs to a same network operator or a same vendor as the first intent manager, and wherein the second set of information comprises information relating to capabilities of the first intent manager for a feature in the communications network that should only be used by the second intent manager.

According to another aspect, a method performed by an intent owner in a communications network for discovering an intent manager profile is provided. The method includes obtaining a first private encryption key, wherein the first private encryption key is associated with a first public encryption key. The method includes generating a first message, the first message comprising a discovery request for an intent manager. The method includes transmitting the first message towards an intent manager registry. The method includes receiving, from the intent manager registry, an intent manager profile corresponding to a first intent manager, wherein the intent manager profile comprises a first set of information and a second set of information, wherein the second set of information has been encrypted using the first public encryption key. The method includes decrypting the second set of information using the first private encryption key. The method includes selecting the first intent manager based on the decrypted second set of information.

In some embodiments, the method further includes receiving a first message, the first message comprising the first set of information. In some embodiments, the method further includes receiving a second message, the second message comprising the second set of information.

In some embodiments, the method further includes receiving a third message, the third message comprising the first set of information and the second set of information.

In some embodiments, the intent manager profile comprises a third set of information, wherein the third set of information has been encrypted using a second public encryption key.

In some embodiments, the first set of information comprises public information about the first intent manager.

In some embodiments, the second set of information comprises capabilities supported by the first intent manager.

In some embodiments, the second set of information supports one or more intents relating to at least one of: optimal performance, cost, or delivery of a proprietary feature in a communications network.

In some embodiments, the intent owner belongs to a same network operator or a same vendor as the first intent manager, and wherein the second set of information comprises information relating to capabilities of the first intent manager for a feature in the communications network that should only be used by the intent owner.

In another aspect there is provided a network node adapted to perform the methods described above. In another aspect there is provided a computer program comprising instructions which when executed by processing circuity of a network node causes the network node to perform the methods described above. In another aspect there is provided a carrier containing the computer program of claim 31, wherein the carrier is one of an electronic signal, an optical signal, a radio signal, and a computer readable storage medium.

### BRIEF DESCRIPTION OF THE DRAWINGS

The accompanying drawings, which are incorporated herein and form part of the specification, illustrate various embodiments.

FIG. 1 illustrates intent manager registration and discovery.

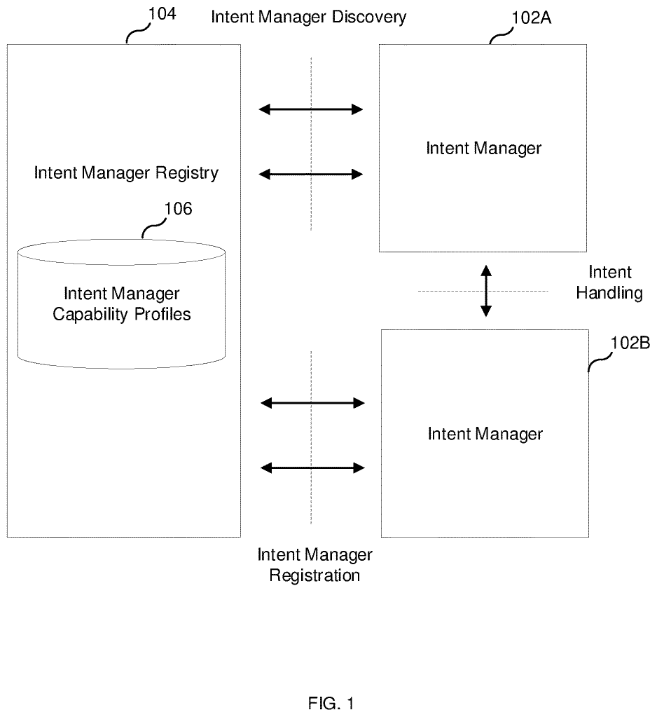

FIG. 2 illustrates classes and properties for expressing intent manager profiles.

FIG. 3 illustrates phases for interactions between intent managers and an intent manager registry, according to some embodiments.

FIG. 4 illustrates a public profile, according to some embodiments.

FIG. 5 illustrates a private profile, according to some embodiments.

FIG. 6 illustrates a public/private profile, according to some embodiments.

FIG. 7 illustrates a graph representation of an example public/private profile, according to some embodiments.

FIG. 8 illustrates a graph representation of an example public/private profile, according to some embodiments.

FIG. 9 is a flow diagram, according to some embodiments.

FIG. 10 is a flow diagram, according to some embodiments.

FIG. 11 is a flow diagram, according to some embodiments.

FIG. 12 illustrates a method, according to some embodiments.

FIG. 13 illustrates a method, according to some embodiments.

FIG. 14 illustrates a block diagram of a network node, according to some embodiments.

### DETAILED DESCRIPTION

A few concepts related to this disclosure are provided below. These concepts are based on the work done in TM Forum's Autonomous Networks, but are also generic enough to be applied in any intent-based management system.

Intent modeling—the intent models are based on ontologies that use the Resource Description Framework (RDF)/Resource Description Framework Schema (RDFS) suite. The ontologies are formed by a mandatory intent common model and optional intent extension models.

Intent models federation—the intent extension models can be created by different organizations and can be federated to create intents that express requirements coming from different management domains.

Intent manager—intents are knowledge objects that need to be lifecycle managed; the intent managers are the logical entity involved in the intent life cycle management. Intent managers can play the role of owners (originator of the requirements) and/or intent handlers (receiving entity that must fulfil the requirements).

Intent owner—intent manager that originates the intents, i.e., the requirements, goals and constraints.

Intent handler—intent manager that fulfils the intents, i.e., receives the intents from an intent owner and fulfils the requirements, goals and constraints.

Intent manager registry—the intent managers exchange intents (as formal definition of the requirements) and intent reports (as formal feedback on the intent fulfilment). The intent managers need to publish and query their capabilities to allow machine-driven automation. The registration and discovery of intent manager capabilities is achieved with the intent manager registries.

Intent manager profile—the list of capabilities of an intent manager (e.g., management scope, supported models, interfaces, notations, etc.).

Aspects of the present disclosure propose techniques to dynamically create different intent manager profiles that are used to expose different intent manager capabilities to be used by specific intent managers in intent-based management. The different intent manager profiles may be created based on a unique identifier of the intent manager requesting such information or its domain, e.g., intent managers from a specific vendor or company. The decision on which capabilities should be included in each different version of an intent manager profile may be based on different types of business decisions, such as, for example, to not expose detailed intent models to competitors and/or to specific industries.

According to some aspects, different intent manager profiles are created using public/private key cryptography, such as the Digital Secure Algorithm (DSA), Rivest-Shamir-Adleman (RSA), Diffie-Hellman, among other examples. In the different intent manager profiles, the capabilities that can be read and used by any intent manager may be transmitted in plain text, e.g., without encryption; and the capabilities that should only be read and used by specific intent managers may be encrypted using the public key of the intended receiver(s), i.e., the specific intent manager(s).

Intents are used to support autonomous networks since it is a way of formally defining the requirements, goals and constraints of the different parties involved in management. Moreover, since intents are formally expressed, they can be generated and processed by machines and enable fully automated systems. The types of requirements, goals and constraints that are used in an intent-driven system can also be dynamically adjusted, which allows machines to have different types of interactions automatically adjusted according to some business-related policies. In this sense, aspects of the present disclosure enable the dynamic exposure of capabilities of intent manager to allow such flexibility.

Some advantages of the proposed solution include, for example:

Dynamic exposure of intent-related capabilities—which types of intents an intent manager is willing to receive from other intent manager can be defined based on the intent extension models that are supported in the intent manager profile. The supported models together with the supported interface procedures can be changed according to any business and/or technical goal/rule. This also allows an intent manager to hide its internal complexity from other competitors, since exposing the intent extension models may give clues about the advance handling capabilities of an intent manager.

Different business relationships between intent managers-the right exposure of intent-related capabilities may allow the establishment of different business relationships between intent managers and the decision about which relationship to create can be taken dynamically (i.e., can change over time) by the intent managers. One company decide to only accept certain types of intents from intent managers from a competitor; two operators may decide to support specialized intent models to be exchanged for optimized network management, or on the other hand, may only expose standardized intent models and hide some of the internal management details that are part of non-standardized intent models; other commercial relationships can be facilitated with different intent manager profiles being created.

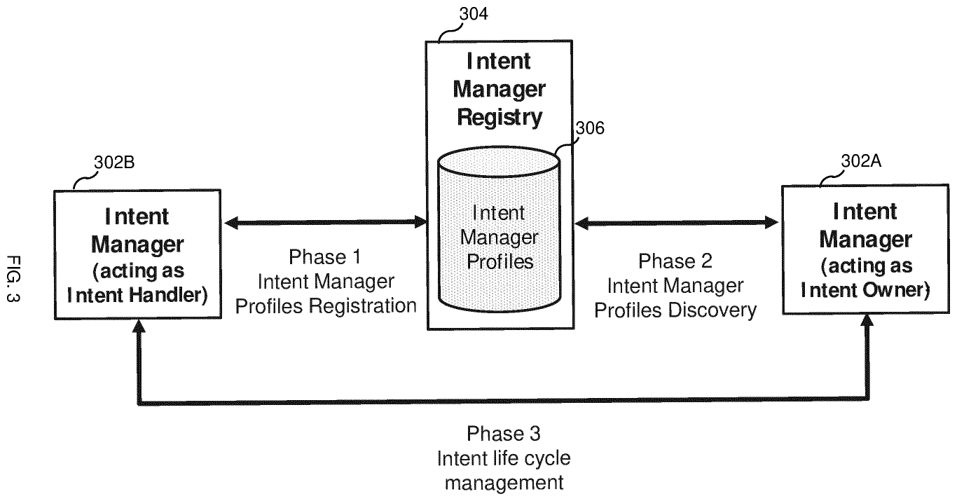

FIG. 3 illustrates phases for interactions between intent managers and an intent manager registry, according to some embodiments. FIG. 3 illustrates an intent manager acting as an intent owner (302A), an intent manager acting as an intent handler (302B), and an intent manager registry (304) with intent manager capability profile database (306). FIG. 3 illustrates three phrases for intent-based management.

Phase 1, i.e., intent manager capability profile registration, involves the registration of the intent manager profiles of all intent managers that are involved in any intent-based management, so that their capabilities can be later discovered by interested intent managers. This phase is required since in intent-based management, different intent managers exchange intents, and these need to be created based on the supported intent extension models and communicated through an interface using the supported interface procedures. Therefore, the intent manager profile is an artifact that needs to be knows by any intent owner that wants to send an intent to any intent handler. All intent managers (302B) must register its own intent manager profiles in a common (set of) intent manager registry(ies) (304).

Phase 2, i.e., intent manager capability profile discovery, involves the discovery of the intent handler's (302B) profile before an intent is created and sent by an intent owner (302A). In principle, this phase involves a simple query that uses filtering criteria such as management scope, any specific domain, e.g., all intent managers from Company X, etc. According to aspects disclosed herein, further steps may be necessary because the intent manager registry (304) has to decide which profile will be sent upon an incoming request based on the requestor identity or its domain (e.g., the intent manager is from Company X.)

Phase 3, i.e., intent life cycle management, involves the different possible operations for the management of intents as information objects. Examples of life cycle management operations are creation of the intent, modification, deletion, query, or optional operations for negotiation of the best intent to be used. Phases 1 and 2 are necessary prior to phase 3, since both sides of intent exchange, i.e., intent owner (302A) and intent handler (302B), need to know each other's capabilities.

According to some aspects, the intent manager profiles that are registered as part of Phase 1 can be of 3 different types: (i) public intent manager profile, a.k.a. “public profile”, (ii) private intent manager profile, a.k.a. “private profile”, (iii) or public and private intent manager profile, a.k.a. “public/private profile”. The “public profile” is not encrypted and can be read by any intent manager, the “private profile” has parts of it encrypted that can only be read by allowed intent managers (that have the right key de decrypt the profile), and the “public/private profile” has some encrypted and unencrypted parts, potentially with encrypted parts using different keys, that can be read by any allowed intent manager that has the right private key to decrypt the parts that are intended for it.

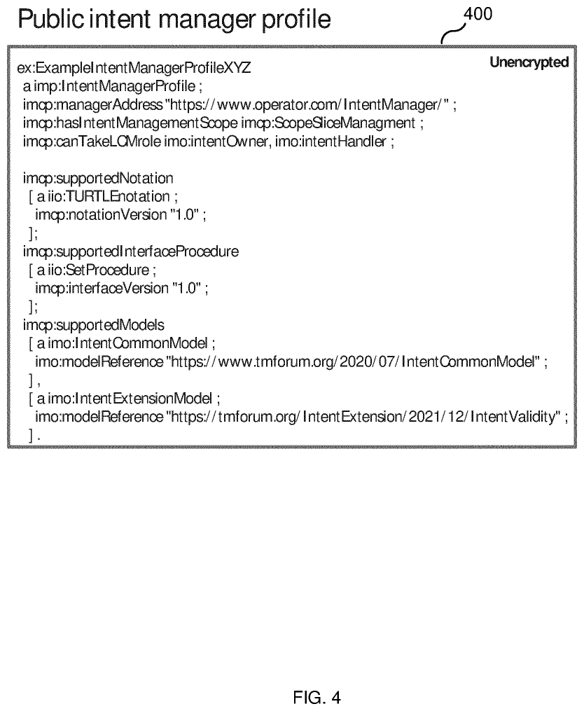

FIG. 4 is an example of public profile, according to some embodiments. The public profile 400 has only plain text and can be read and processed by any intent manager that understands the information model used. In this example shown in FIG. 4, the information model is based on the ontology described in IG1253D [5], but others could be used as well.

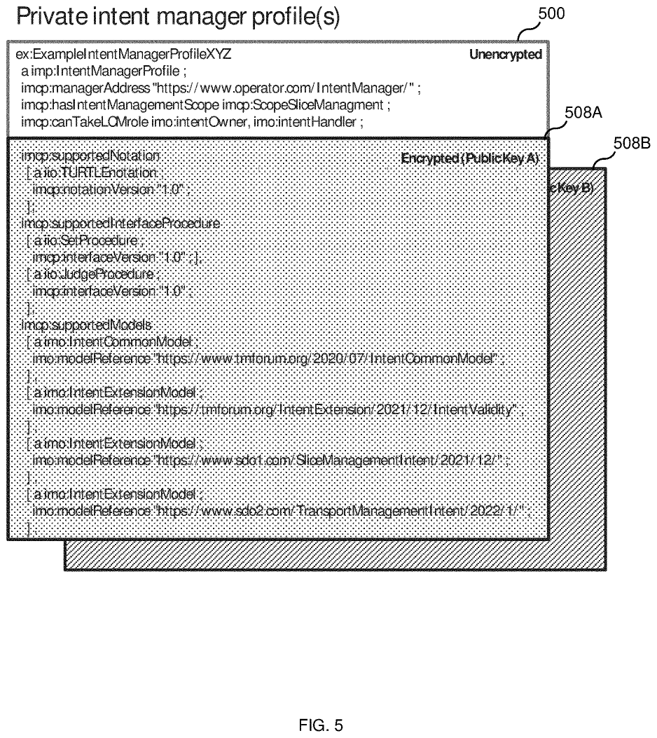

FIG. 5 is an example private profile, according to some embodiments. The private profile has some parts 500 that are in plain text (e.g., unencrypted) and can be read by any intent manager. These parts may contain basic information about the intent manager, such as its address, management scope, etc., that allows the intent manager registry to filter this profile in the registry database and send it to the appropriate requestor, e.g., when an intent owner queries intent handlers with specific management scopes. The private profile has some parts (508A or 508B) that are encrypted and can only be read by an intent manager that has the appropriate decryption key. In some embodiments, a private profile only has one of parts 508A or 508B, whereas a public/private profile may have both of parts 508A and 508B.

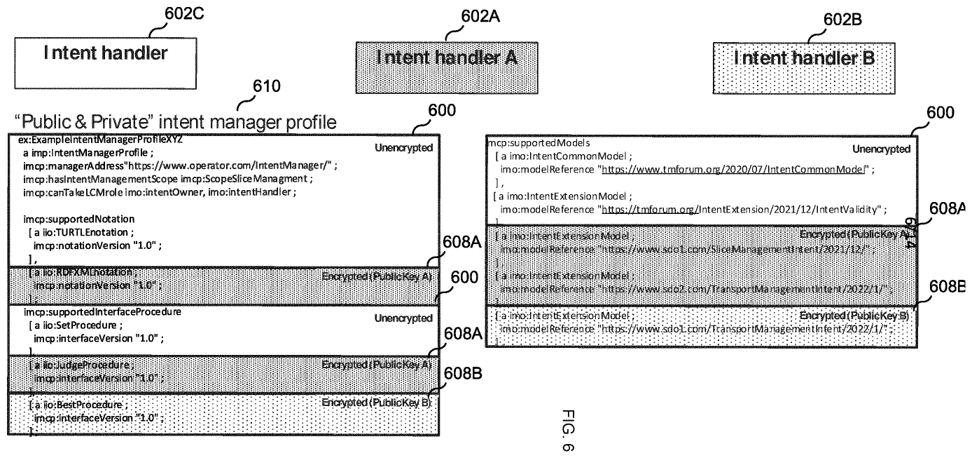

FIG. 6 is an example public/private profile, according to some embodiments. In some embodiments, the public/private profile (610) is a special case of a “private profile” since it has parts that are in plain text (600) and parts that are encrypted (608A, 608B), but the encrypted parts may be encrypted using different public keys, which means that each of the encrypted part may be intended to be read and understood by a different (set of) intent owner(s). In the case shown in FIG. 6, there are some capabilities in the intent manager profile (610), e.g., the RDFXMLnotation and JudgeProcedure, that can only be used by intent manager A (602A) because only intent manager A has the private key A and is able to decrypt the encrypted parts (608A) for that intent manager. Similarly, in FIG. 6, only intent manager B (602B) has the private key B and is able to decrypt the encrypted parts (608B) for that intent manager. As shown in FIG. 6, any other intent managers (602C) may only be able to see the unencrypted portions (600) of the public/private profile (610).

In some embodiments, the information model considered to express the intent manager profiles are based on the Resource Description Framework (RDF), the profiles can also be seen as a graph. In some embodiments, the proposed techniques herein encrypt individual nodes in this graph, so that only specific intent managers (the ones having the right private keys) are capable to read and process such nodes.

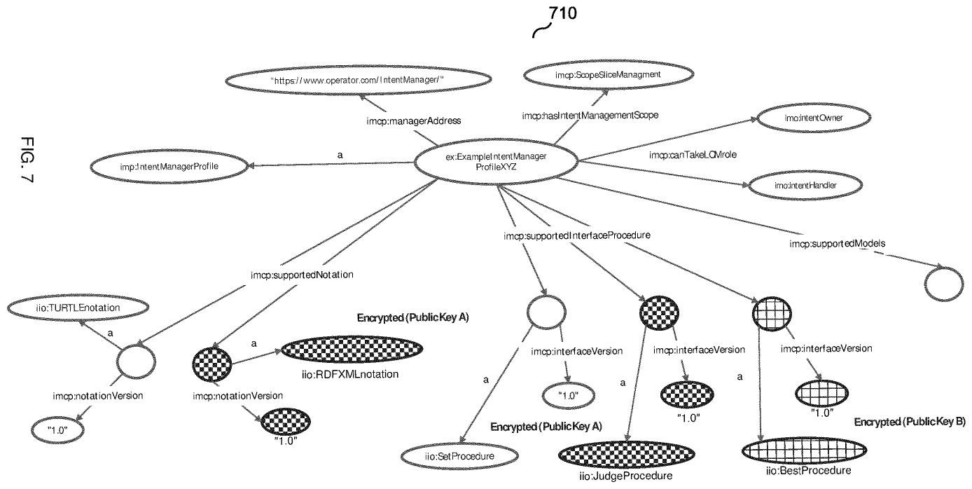

FIG. 7 shows a graph representation of a “public/private profile” 710 where the patterned nodes are encrypted with specific public keys and can only the read by specific intent managers.

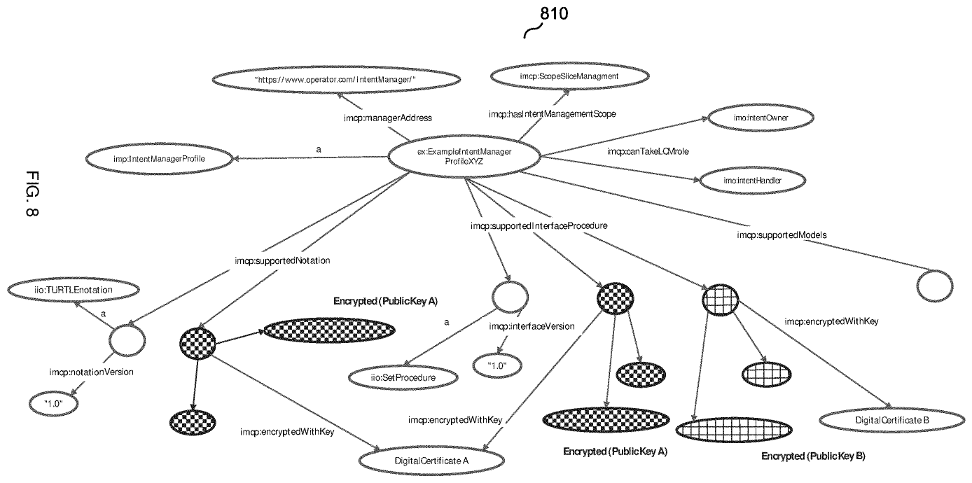

FIG. 8 shows the same graph 810 with an added ontology that allows defining within the graph the digital certificates used to encrypt each node.

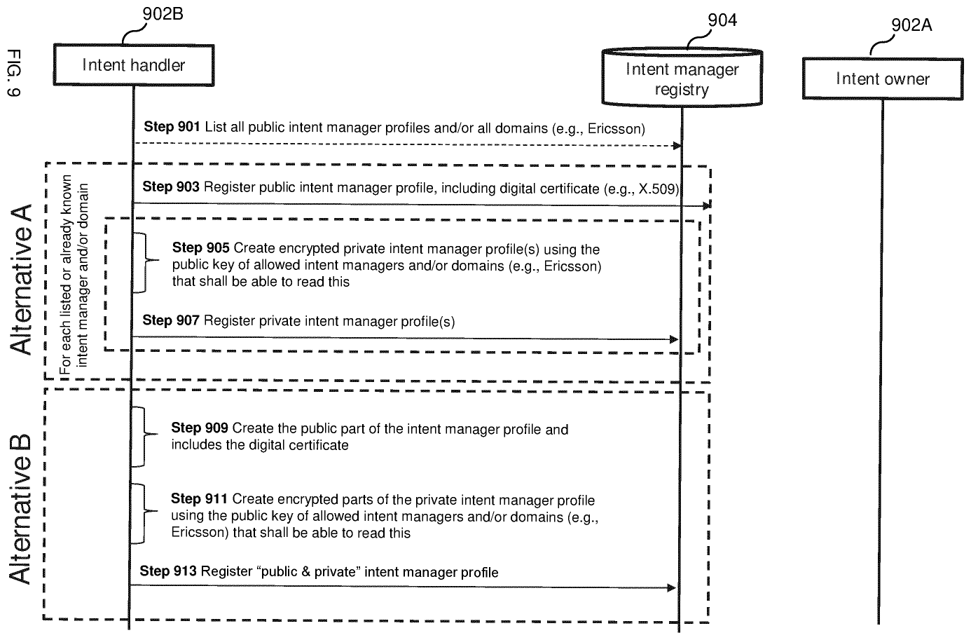

FIG. 9 is a flow diagram, according to some embodiments. FIG. 9 illustrates aspects of phase 1, i.e., intent manager profile registration between an intent handler (902B) and an intent manager registry (904).

At step 901, all public intent manager profiles and/or all domains are listed. In some embodiments, all intent managers (902B) that may want to create intent manager profiles with some private or encrypted parts need to know the public key of intended intent managers. The public keys can be obtained with digital certificates, e.g., X.509. These digital certificates can be obtained through different methods, e.g., via a certificate authority, or via the intent manager registry (904), since all public intent manager profiles include the intent manager certificate. Step 901 shows an optional case where the intent manager registry (904) is responsible to distribute the digital certificates; in this case a secure channel should be used, similarly to the case where a certificate authority is involved.

Steps 903, 905, and 907 are used if the intent manager (902B) decides to create a “public profile” and “private profiles” for every known intent manager and/or domain.

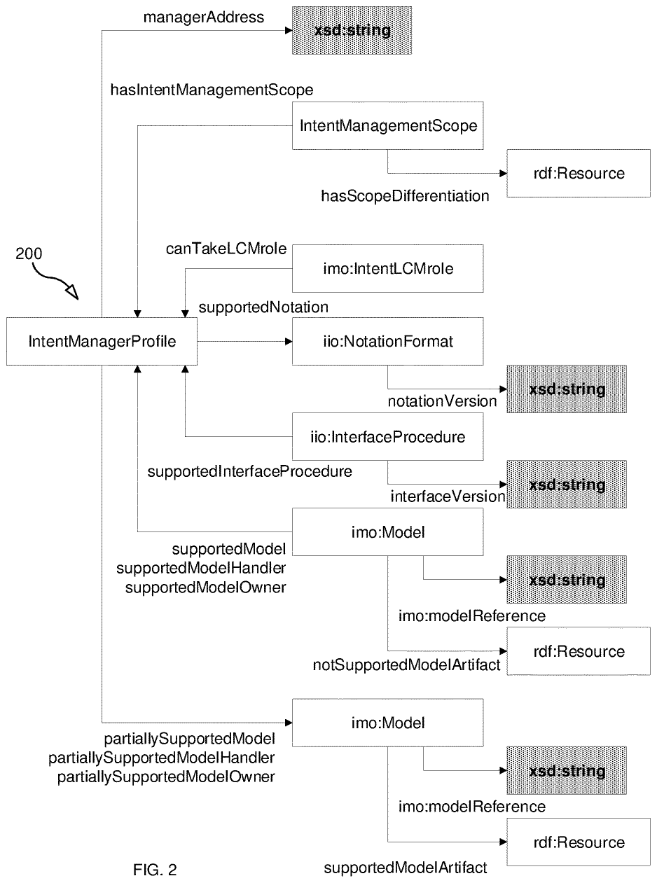

At step 903, the intent manager (902B) registers its “public profile” with capabilities that are intended to be used by all other intent managers (902B). The information that composes an intent manager profile can be standardized or proprietary. One relevant standard is IG1253D, and its intent manager profile is shown in FIG. 2, as described above. The registered profile should include the intent manager's (902B) certificate with its public key that will be used by other intent managers to create “private profiles.”

At step 905, for every intent manager that was listed in Step 901, or that is already known by any means, the intent manager (902B) will consider the creation of a “private profile”. The “private profile” has some parts that are encrypted using the intended intent manager public key, or a public key that can be used by any intent manager within a particular domain.

At step 907, all “private profiles” that were created should be registered in the intent manager registry (904) to be later sent to the intended intent owners (902A).

Steps 909, 911, and 913 are used if the intent manager (902B) decides to create a “public/private profile.”

At step 909, the intent manager (902B) creates the unencrypted parts of the “public/private profile” and includes its digital certificate.

At step 911, for all intended intent manager(s), the encrypted parts of the “public/private profile” are created using the public key of the intended intent manager or of a particular domain.

At step 913, the “public/private profile” that was created is registered in the intent manager registry (904).

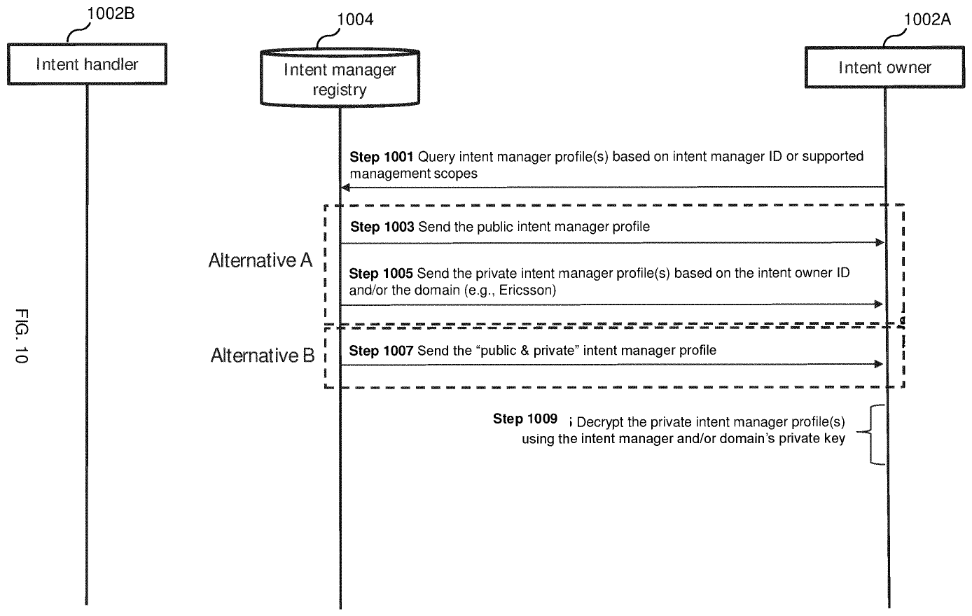

FIG. 10 is a flow diagram, according to some embodiments. Aspects of FIG. 10 focus on Phase 2, i.e., intent manager profiles discovery.

At step 1001, an intent owner (1002A) that has an intent has to find the most appropriate intent handler (1002B) to fulfil that given intent. The discovery of the best intent handler can be done by querying the intent manager registry (1004) using the intent handler ID, if already known, or any other applicable filters.

An example of common filtering criteria is the intent management scope. Management scope is the delineation of responsibility for operational tasks within a system domain or sub-system. By associating a defined scope, the intent manager claims that it is the responsible entity for all intent targeting this scope.

Examples of intent management scopes are (as exemplified in IG1253D) include, for example: (a) at the business layer—contract negotiation scope, order management scope, regulatory policies scope, operator policies scope; (b) at the service layer—service orchestration and assurance scope; and/or (c) at the resource operation layer-core network intent management scope, transport management scope, slice management scope, network function management scope.

After an intent manager profile discovery, there are two possibilities for the reply that is sent by the intent manager registry (1004). Alternative A is to send the “public profile” (step 1003) and all available “private profiles” (step 1005) that are intended to the intent owner (1002A) issuing the request. Alternative B is to send the available “public/private profile” (step 1007).

At step 1003, the intent manager registry (1004) sends the “public profile” to the intent owner (1002A). There may be multiple “public profiles” that are applicable to the filtering criteria. Each profile corresponds to one specific intent handler and can be read by any intent manager because it is not encrypted.

At step 1005, the intent manager registry (1004) sends the “private profile” that is intended to be decrypted by the intent owner (1002A). There may be multiple “private profiles” that are applicable to the filtering criteria. Each profile corresponds to one specific intent handler and is intended specifically to the intent owner querying, since it has been encrypted using the intent owner's public key.

At step 1007, the intent manager registry (1004) sends the “public/private profile”. There may be multiple “public/private profiles” that are applicable to the filtering criteria. Each profile corresponds to one specific intent handler, and it may have parts that are encrypted using the intent owner's public key and other parts that are encrypted with public keys from other intent managers.

At step 1009, after the intent manager profiles are received by the intent owner (1002A), the intent owner can decrypt the encrypted parts of the “private profile(s)” and of the “public/private profile(s)” using its private key or its domain's private key.

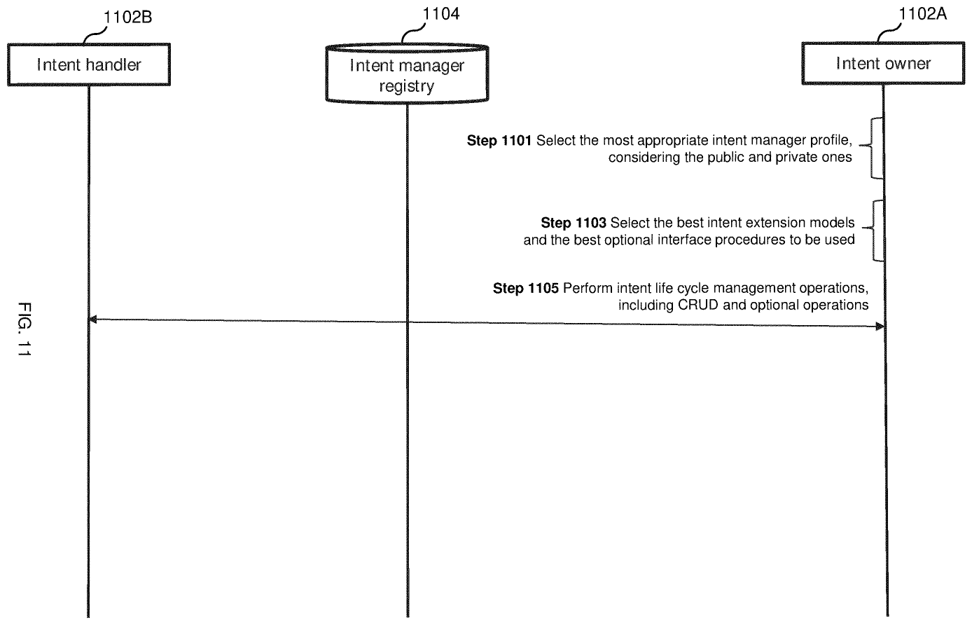

FIG. 11 is a flow diagram, according to some embodiments. Aspects of FIG. 11 focus on Phase 3, i.e., intent life cycle management. These steps may be taken during intent-driven management.

At step 1101, the intent owner (1002A) has to select the best intent manager (1002B) to be used for the intent exchange and, possibly, negotiation, etc. It should consider the different capabilities, i.e., supported extension models, supported interface procedures, etc. that are part of the public and private parts present in the different intent manager profiles received.

At step 1103, after the selection of the best intent manager to be considered as an intent handler, the intent owner (1002A) has to select the best intent extension model(s) to create the intent object and, optionally, the best interface procedures to perform intent negotiation and other advanced life cycle management of the intent object.

At step 1105, with the selected intent handler and the creation of the intent object, the intent life cycle management operations can be performed. These operations can be performed using standardized APIs such as TMF921A, or other intent-based APIs from other standards groups, e.g., 3GPP.

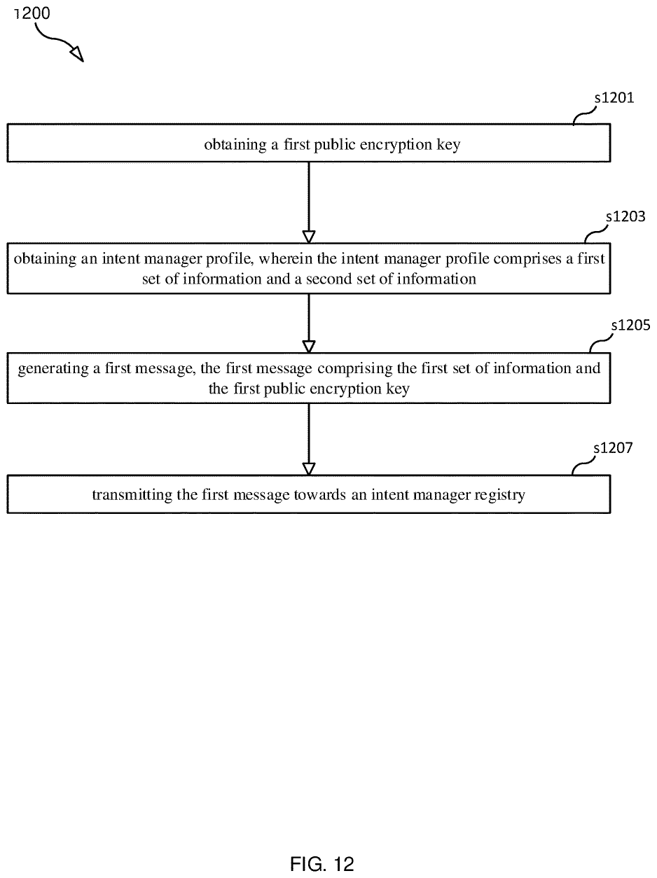

FIG. 12 is a method, according to some embodiments. In some embodiments, method 1200 is performed by a first intent manager in a communications network for registering an intent manager profile.

Step s1201 includes obtaining a first public encryption key.

Step s1203 includes obtaining an intent manager profile, wherein the intent manager profile comprises a first set of information and a second set of information.

Step s1205 includes generating a first message, the first message comprising the first set of information and the first public encryption key.

Step s1207 includes transmitting the first message towards an intent manager registry.

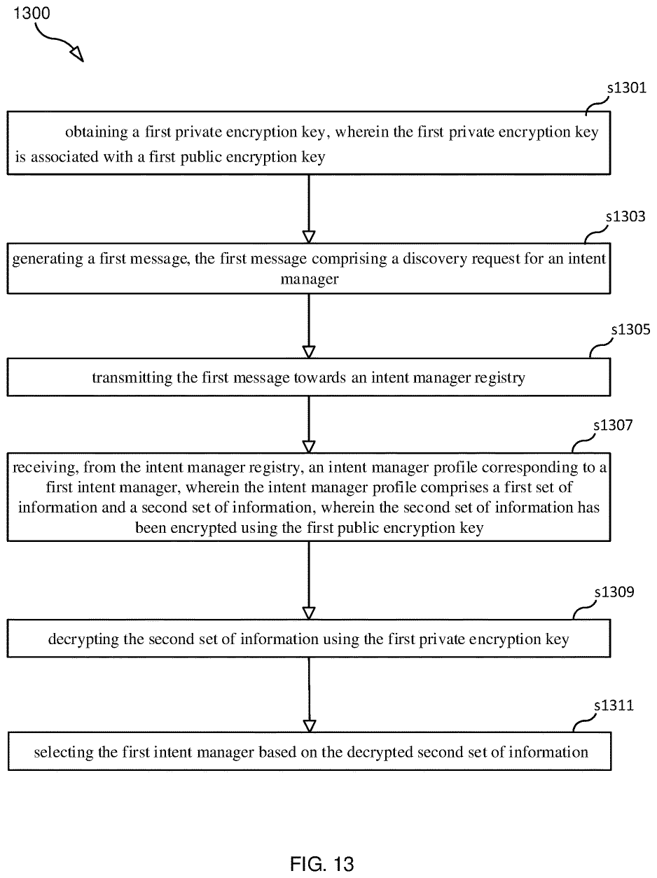

FIG. 13 is a method, according to some embodiments. In some embodiments, method 1300 is performed by an intent owner in a communications network for discovering an intent manager profile.

Step s1301 includes obtaining a first private encryption key, wherein the first private encryption key is associated with a first public encryption key.

Step s1303 includes generating a first message, the first message comprising a discovery request for an intent manager.

Step s1305 includes transmitting the first message towards an intent manager registry.

Step s1307 includes receiving, from the intent manager registry, an intent manager profile corresponding to a first intent manager, wherein the intent manager profile comprises a first set of information and a second set of information, wherein the second set of information has been encrypted using the first public encryption key.

Step s1309 includes decrypting the second set of information using the first private encryption key.

Step s1311 includes selecting the first intent manager based on the decrypted second set of information.

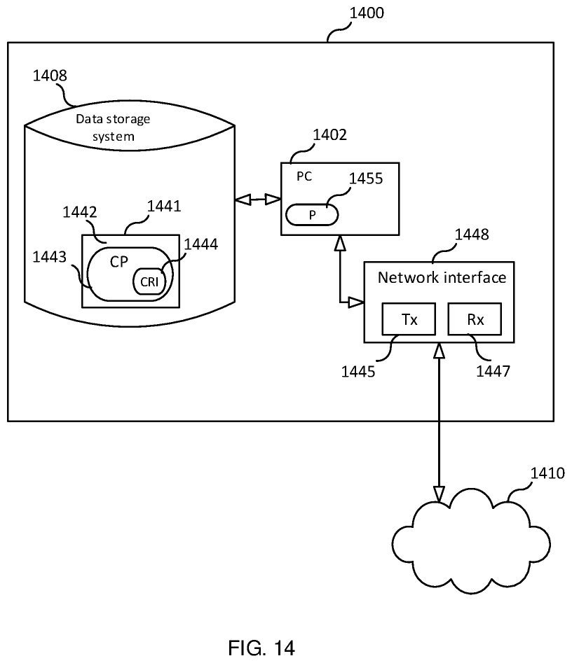

FIG. 14 is a block diagram of a network node 1400 according to some embodiments. In some embodiments, network node 1400 may comprise one or more of the components of an intent handler and/or intent owner as described herein. As shown in FIG. 14, the node may comprise: processing circuitry (PC) 1402, which may include one or more processors (P) 1455 (e.g., one or more general purpose microprocessors and/or one or more other processors, such as an application specific integrated circuit (ASIC), field-programmable gate arrays (FPGAs), and the like); communication circuitry 1448, comprising a transmitter (Tx) 1445 and a receiver (Rx) 1447 for enabling the node to transmit data and receive data (e.g., wirelessly transmit/receive data) over network 1410; and a local storage unit (a.k.a., “data storage system”) 1408, which may include one or more non-volatile storage devices and/or one or more volatile storage devices. In embodiments where PC 1402 includes a programmable processor, a computer program product (CPP) 1441 may be provided. CPP 1441 includes a computer readable medium (CRM) 1442 storing a computer program (CP) 1443 comprising computer readable instructions (CRI) 1444. CRM 1442 may be a non-transitory computer readable medium, such as, magnetic media (e.g., a hard disk), optical media, memory devices (e.g., random access memory, flash memory), and the like. In some embodiments, the CRI 1444 of computer program 1443 is configured such that when executed by PC 1402, the CRI causes the node to perform steps described herein (e.g., steps described herein with reference to the flow charts). In other embodiments, the node may be configured to perform steps described herein without the need for code. That is, for example, PC 1402 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### REFERENCES

[1] IG1253—TM Forum—“Intent in Autonomous Networks”
[2] TR290—TM Forum—“Intent Common Model”
[3] TR291—TM Forum “Intent Extension Models”
[4] IG1253C—TM Forum—“Intent Life Cycle Management and Interface”
[5] IG1253D—TM Forum—“Intent Manager Capability Profiles”
[6] TMF921A—TM Forum—“Intent Management API Profile”

### ABBREVIATIONS

RDF Resource Description Framework
RDFS RDF Schema
SMO Service Management and Orchestration
ZSM Zero-touch Network and Service Management

1. A method performed by a first intent manager in a communications network for registering an intent manager profile, the method comprising:
obtaining a first public encryption key;
obtaining an intent manager profile, wherein the intent manager profile comprises a first set of information and a second set of information;
generating a first message, the first message comprising the first set of information and the first public encryption key; and
transmitting the first message towards an intent manager registry-(104,

2. The method of claim 1, further comprising:
obtaining a second public encryption key associated with a second intent manager-(102A, and
encrypting the second set of information using the second public encryption key.

3. The method of claim 2, further comprising:
generating a second message, the second message comprising the encrypted second set of information; and
transmitting the second message towards the intent manager registry.

4. The method of claim 2, further comprising:
generating a third message, the third message comprising the first set of information, the first public encryption key, and the second set of information; and
transmitting the third message towards the intent manager registry.

5. The method of claim 1, further comprising:
obtaining the second public encryption key from the intent manager registry or a certificate authority.

6. The method of claim 1, wherein the intent manager profile comprises a third set of information, the method further comprising:
obtaining a third public encryption key of a third intent manager; and
encrypting the third set of information using the third public encryption key.

7. The method of claim 1, wherein the first set of information comprises public information about the first intent manager.

8. The method of claim 1, wherein the second set of information comprises capabilities supported by the first intent manager that should be interpreted by the second intent manager and not a third intent manager different than the second intent manager.

9. The method of claim 1, wherein the second set of information supports one or more intents relating to at least one of: optimal performance, cost, or delivery of a proprietary feature in a communications network.

10. The method of claim 1, wherein the second intent manager belongs to a same network operator or a same vendor as the first intent manager, and wherein the second set of information comprises information relating to capabilities of the first intent manager for a feature in the communications network that should only be used by the second intent manager.

11. A method performed by an intent owner in a communications network for discovering an intent manager profile, the method comprising:
obtaining-(s1301) a first private encryption key, wherein the first private encryption key is associated with a first public encryption key;
generating a first message, the first message comprising a discovery request for an intent manager;
transmitting the first message towards an intent manager registry receiving, from the intent manager registry, an intent manager profile corresponding to a first intent manager wherein the intent manager profile comprises a first set of information and a second set of information, wherein the second set of information has been encrypted using the first public encryption key;
decrypting the second set of information using the first private encryption key; and
selecting the first intent manager based on the decrypted second set of information.

12. The method of claim 11, further comprising:
receiving a first message, the first message comprising the first set of information.

13. The method of claim 12, further comprising:
receiving a second message, the second message comprising the second set of information.

14. The method of claim 11, further comprising:
receiving a third message, the third message comprising the first set of information and the second set of information.

15. The method of claim 1, wherein the intent manager profile comprises a third set of information, wherein the third set of information has been encrypted using a second public encryption key.

16. The method of claim 11, wherein the first set of information comprises public information about the first intent manager.

17. The method of claim 11, wherein the second set of information comprises capabilities supported by the first intent manager.

18. The method of claim 11, wherein the second set of information supports one or more intents relating to at least one of: optimal performance, cost, or delivery of a proprietary feature in a communications network.

19. (canceled)

20. A network node adapted to:
obtain a first public encryption key;
obtain an intent manager profile, wherein the intent manager profile comprises a first set of information and a second set of information;
generate a first message, the first message comprising the first set of information and the first public encryption key; and
transmit the first message towards an intent manager registry.

21. (canceled)

22. (canceled)

23. A network node adapted to:
obtain a first private encryption key, wherein the first private encryption key is associated with a first public encryption key;
generate a first message, the first message comprising a discovery request for an intent manager;
transmit the first message towards an intent manager registry;
receive, from the intent manager registry, an intent manager profile corresponding to a first intent manager, wherein the intent manager profile comprises a first set of information and a second set of information, wherein the second set of information has been encrypted using the first public encryption key;
decrypt the second set of information using the first private encryption key; and
select the first intent manager based on the decrypted second set of information.
